(19) United States
(12) Patent Application Publication
(10) Pub. No.: US 2003/0072432 A1
(43) Pub. Date: Apr. 17, 2003

(54) Call waiting indicator

(76) Inventor: Claran Kelly, Galway (IE)

Correspondence Address: William M. Lee, Jr., Lee, Mann, Smith, McWillams, Sweeney & Ohlson, Suite 410, 209 South LaSalle Street, Chicago, IL, 60604-1202, US

(21) Appl. No.: 09/975,838

(22) Filed: Oct. 12, 2001

(51) Int. Cl. H04M 3/42

(52) U.S. Cl. 379/215.01

(57) ABSTRACT

A call waiting indicator comprises a tone detector which is provided in a computer which has a telephony connection. The tone detector receives an input from the telephony connection and identifies or determines a signal which is indicative of a waiting call. An alert generator connected to the tone detector is configured to alert the user of the computer via an output device of the computer that a call waiting signal has been detected. In this way, a user can be connected to the Internet yet still receive a visual or aural alert of the existence of a waiting call. The waiting call can then be taken via a handset, fax machine or via telephony software on the computer.

### TECHNICAL FIELD

This invention relates to telecommunications systems which provide an indication to a user of a waiting call when a first call is active.

### BACKGROUND ART

Current digital exchanges are capable of maintaining two or more calls to the same end user. Typically, a use will be involved in a call to or from a remote first party via the exchange when a second pay tries to telephone the user. The user's local public switched telephone network PSTN) exchange receives the second call and places it on hold. A characteristic audio tone is added to the signal of the first telephone call as an indication to the user that a call is waiting, and typically the exchange will also play a recorded message to the second caller indicating that the user's line is busy but that a “call waiting” indication has been sent to the user.

Because many people now use a single telephone line for both voice telephony calls and data sessions from a computer (e.g. Internet access), it is frequently necessary for the user to disable the call waiting facility due to the fact that the call waiting tones can cause the Internet connection to be lost. Indeed, the current most widely used Web browser software, Microsoft Internet Explorer (Trade Mark) recommends disabling call waiting facilities as a possible fix to Internet connection problems in its troubleshooter program.

Even if the call waiting tone does not cause the Internet connection to be lost, there is still a problem in that a user with an active Internet connection has no way of knowing whether or not a call is waiting. In households where a number of people rely on the same telephone line for both Internet access and voice telephony, this may act as a disincentive for use of the Internet, since when on-line the Internet user will monopolise the telecommunications facilities by preventing either outbound or inbound calls to be made or taken.

A possible solution to this problem, which is far from ideal, is the installation of a second telephone line. This involves additional installation costs and nag costs.

An alternative to the installation of a second telephone line is the installation of a more expensive upgrade to a standard line (e.g. installation of an ISDN line) which allows two calls to be maintained simultaneously.

The “Call Manager” software from Nortel Networks Corporation enables a PSTN exchange to send a message to an Internet user's PC client software when an incoming call is waiting. A drawback with this solution is that the telephone company must upgrade the PSTN exchange equipment to provide this message to the user's PC,

### SUMMARY OF THE INVENTION

The invention provides a call waiting indicator having a tone detector which is associated with a computer which has a telephony connection. The tone detector receives an input from the telephony connection and identifies or determines a signal which is indicative of a waiting call. A signal generator connected to the tone detector is configured to generate a signal to software resident on the computer upon detection of a call waiting signal, so that the software can alert a user of the computer via an output device of the computer that a call waiting signal has been detected.

Without having to make any modifications to the PSTN exchange, therefore, the invention enables a computer user to be alerted to the existence of a waiting call. Very little modification is required to the user's computer system other than the addition of the call waiting indicator which may be embodied on a “plug and play” PC card. The card can communicate with software on the computer which generates the user alerts.

The tone detector preferably comprises an audio signal sampler for sampling the input signal, a sample store for storing a sample call waiting signal, and a matching unit for determining whether a match exists between a sample of the input signal and a stored sample.

The call waiting indicator may also include a configuration unit for selecting one or more sample signals from a number of available signals and for storing the selected signal(s) in the sample store.

In this way, the indicator, or a piece of software accompanying the indicator, may be supplied to users with a database of sample signals, and the sample(s) matching the call waiting signal(s) generated by the user's telephony provider can be selected and stored for comparison. This could be done by associating with each sample the names of the telephony providers in each country who use that particular signal. It could also be done automatically by the software in a configuration program in which the user is requested to place at incoming call to the telephony connection when the connection is active, so that the software can recognise the tone and determine the best match.

Preferably, the signal generator communicates with alert generation software resident on the computer, the software including instructions effective to recognise a signal from the signal generator and to generate an alert to a user of the computer via said interface.

Alternatively, the signal generator could communicate with the operating system of the computer and include a command generator for generating a command to the operating system causing the operating system to generate the alert.

The invention also provides a computer system comprising:

a) a port for a telephony connection;

b) a processor;

c) a telecommunications manager for managing the transfer of data between the processor and the port;

d) a user interface connected to the processor comprising at least an output device capable of issuing an alert to a user;

e) a tone detector connected to the port, the tone detector comprising an input for receiving a signal from the telephony connection and a discriminator for identifying a signal indicative of a waiting call; and

f) a signal generator connected to the tone detector and configured to generate a signal when a call waiting signal has been detected, whereby a user of the computer can be alerted to the waiting call.

The signal generator preferably communicates with alert generation software resident on the computer, said software comprising instructions effective to recognise a signal from the signal generator and to generate an alert to a user of the computer via said interface.

The alert may include an option for the user to terminate an existing data session under the control of the telecommunications manager, and the interface may further include an input device for enabling the user to select the option.

Thus, a user on the Internet would typically see an alert dialog box with an indication of a waiting call on the line when the call waiting signal is detected, and an option in the dialog box would allow the user to close the Internet connection (if desired) when the call is being answered. Alternatively, the user might decide to place the Internet call on hold and take the waiting call, in which case the telephony control software on the computer could generate the necessary call control signals. The incoming call can be answered using a conventional handset connected to the telephony connection or a virtual handset on the computer itself. The software for the virtual handset could be launched automatically when the user selects to take the incoming call.

Thus, the system preferably further includes a call control signal generator for outputting a call control signal to the connection to control the remote handling of the waiting call and/or the data session.

The output device may be a loudspeaker in which case the alert includes an audio alert, or the output device may be a display unit and the alert is a visible alert displayed on the display unit. Both audio and visual alerts can be issued.

The telecommunications manager can control a modem connected to the port and the input to the tone detector may be taken from the input or output of the modem.

Preferably, the tone detector and the signal generator are embodied on a PC card mounted on the computer.

The invention further provides a computer program comprising instructions which when executed on a computer are effective to cause the computer to:

a) monitor a telephony input signal to the computer during a data transfer between the computer and a telephony connection;

b) detect a signal indicative of a waiting call available from the telephony connection; and

c) upon detection of a signal indicative of a waiting call, generate a signal to the computer whereby an alert can be provided to a user of the computer via an output device of the computer.

In a preferred embodiment, the instructions are implemented in the firmware of a PC card.

The invention further provides a piece of software effective to:

a) monitor a PC card input signal to the computer for a signal indicative of a waiting call detected by the PC card; and

b) upon detection of a signal indicative of a waiting call, generate an alert to a user of the computer via an output device of the computer.

The alert may include a user-selectable option to terminate the data transfer (i.e. transfer to the call while ending the data transfer) or to place the data transfer on hold (i.e. toggle between calls).

The program can include instructions to present a user with a tool for selecting one or more signals indicative of a waiting call from a plurality of candidate signals accessible from the computer, in the configuration mode.

The software is then used to configure the PC card by pro ng it with the identity of the call waiting signal which it should monitor for.

The invention provides, in another aspect, a database comprising a plurality of signal identifiers, each signal identifier being characteristic of a call waiting signal generated by a PSTN exchange and enabling a match to be made between the identifier and an incoming telephony signal to a computer connected to the exchange.

A further aspect of the invention provides a method of alerting a user of a computer to a waiting call available from a telephony connection to which the computer is connected, the method comprising the steps of:

a) monitoring a telephony input signal to the computer during a data transfer between the computer and a telephony connection;

b) detecting a signal indicative of a waiting call available from the telephony connection; and

c) upon detection of a signal indicative of a waiting call, generating an alert to a user via an output device of the computer.

further comprising the step of providing a user of the computer with an option to terminate or place on hold the existing data session.

The invention also provides a telecommunications system comprising a connection to a telephony network, a computer system connected to the connection and a telephony terminal connected to the connection, wherein the computer system comprises:

a) a port for the telephony connection;

b) a processor;

c) a telecommunications manager for managing the transfer of data between the processor and the port;

d) a user interface connected to the processor comprising at least an output device capable of issuing all alert to a user;

e) a tone detector connected to the port, the tone detector comprising an input for receiving a signal from the telephony connection and a discriminator for identifying a signal indicative of a waiting call; and

f) an alert generator connected to the tone detector and configured to alert a user of the computer via the interface that a call waiting signal has been detected;

whereby upon the alert being generated, the waiting call can be taken at the telephony terminal.

In yet a further aspect there is provided a telecommunications network comprising a plurality of interconnected exchanges, at least one of the exchanges including a call waiting signal generator for generating a call waiting signal when a call is placed to an endpoint at which an existing call is in progress, and an endpoint connected to the one of the exchanges, the endpoint comprising a computer system connected to the exchange and a telephony terminal connected to the exchange, wherein the computer system comprises:

a) a port for connection to the exchange;

b) a processor;

c) a telecommunications manager for managing the transfer of data between the processor and the port;

d) a user interface connected to the processor comprising at least an output device capable of issuing an alert to a user;

e) a tone detector connected to the port, the tone detector comprising an input for receiving a signal from the telephony connection and a discriminator for identifying a signal indicative of a waiting call; and

f) an alert generator connected to the tone detector and configured to alert a user of the computer via the interface that a call wailing signal has been detected;

whereby upon the alert being generated, the waiting call can be taken at the telephony terminal.

Preferably, the computer further comprises a call control signal generator for outputting a call control signal to the exchange, and the, exchange further includes a call manager responsive to the call control signal to control the handling of the waiting call and/or the data session.

### BRIEF DESCRIPTION OF THE DRAWINGS

The invention will now be further illustrated by the following description of embodiments thereof given by way of example only with reference to the accompanying drawings, in which:

FIG. 1 is a flowchart illustrating the operation of a preferred method of the invention; and

FIG. 2 is a block diagram of a computer system according to the invention which includes an inventive call waiting indicator.

### DETAILED DESCRIPTION OF PREFERRED EMBODIMENTS

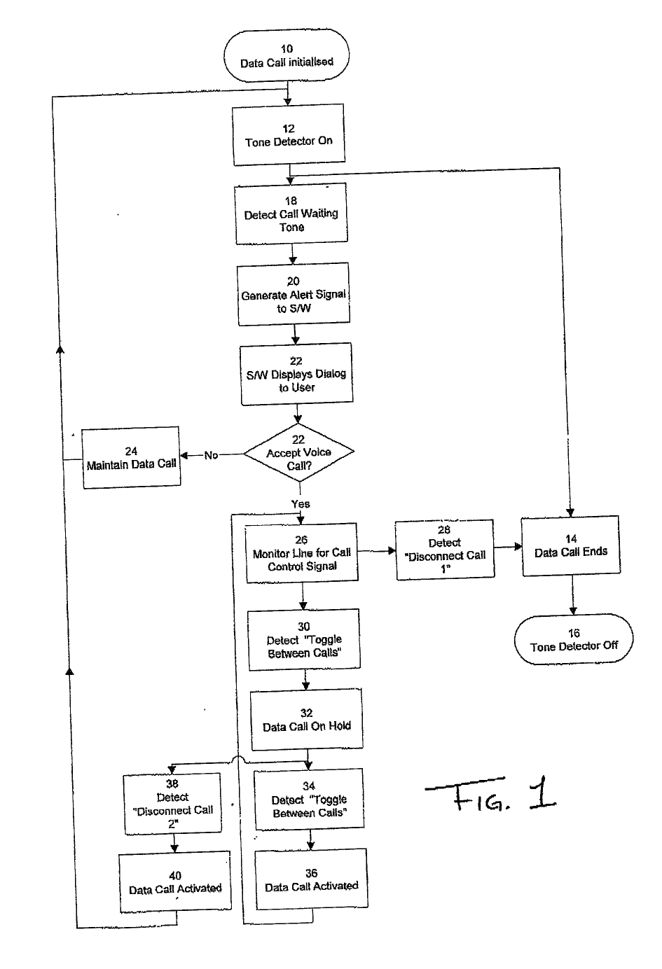

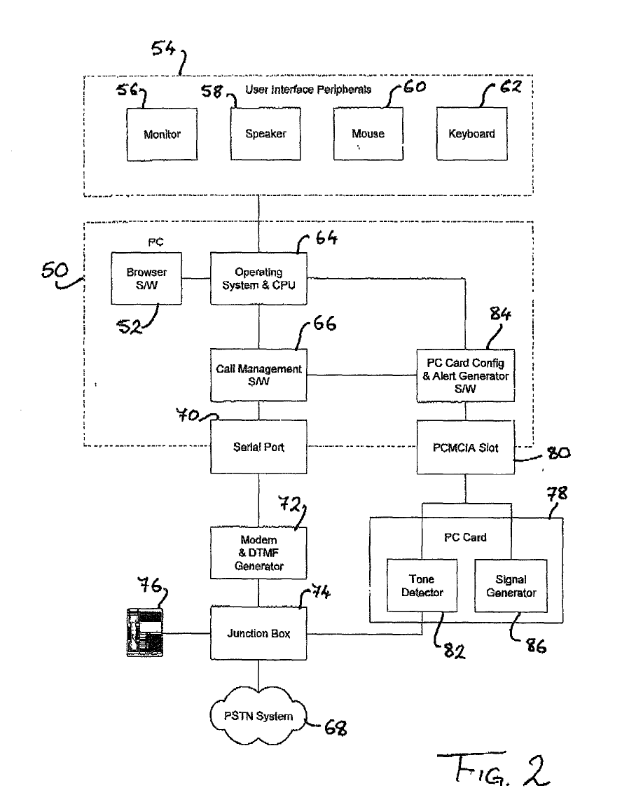

In FIG. 1 there is shown a flowchart which implements a method of the, invention, and which illustrates the operation of a PC Car and associated software according to the, invention running on a computer. FIG. 1 will be described with additional reference to FIG. 2, which is a block diagram of the computer system.

The invention is used when the computer is involved in a first telephony call which is typically a data call, step 10, such as an Internet session in which a user employs a PC 50 (FIG. 2) having a browser 52, a user interface 54 (typically including a monitor 56, speaker 58, mouse 60 and keyboard 62), and a CPU and operating system 64, all of which are well known in the art.

The computer receives and sends signals via call management software 66 which implements a communications protocol such as TCP/IP to communicate with remote computers via the PSTN 68. The call management software connects to a port of the computer, such as a serial port 70 to which a modem 72 is connected. Modem 72 converts signals between the digital signals generated by the computer and the analog signals carried over the PSTN 68. The modem connects into a junction box 74 which also has a conventional handset 76 connected to it, so that the same telephony connection can be used for both voice calls from the handset and data calls from the computer (the data calls from the computer could also be voice over IP (VoIP) calls made via the Internet, in which case the computer would have VoIP software and a microphone or an attached ethernet set).

In addition to the conventional components described above, the computer system according to the invention includes a PC card 78 mounted in a PCMCIA card slot 80. The card 78 includes a telephony connection which is also connected to the junction box 74 so that it receives all of the signals passing to and from the PSTN system (both from the modem 72 and the handset 76).

A tone detector 82 is embodied in the firmware of the card 78 and is adapted to receive and recognise the electrical signals corresponding to call waiting tones of the type generated by suitable exchanges and which are normally converted by a telephone such as handset 76 into an audible beep signal which enables a caller at the handset to switch between calls. In the present invention, the tone detector is configured by a PC card configuration program 84 with the identity of the tones which are to be monitored for (whether by a user choosing the tones or by the software using the location information stored on the computer to decide on the type of tone expected for the PSTN system to which the computer is connected).

Thus, when the data call is in progress, the PC card is activated and the tone detector begins to monitor signals traveling across the line from the PSTN system, step 12. It does this by sampling the signals received from the PSTN, and using a matching algorithm to detect a match between the received signal and the characteristic signal expected for the “call waiting” signal which it has been configured to detect.

In many cases, the data call will end without. Any can waiting signal being detected, step 14, in which case the tone detector 82 is simply deactivated until the next call.

If, however, a call waiting signal is detected by the tone detector, step 18, a signal generator 86 also embodied in the firmware of the PC card generates a signal via the PCMCIA slot to the PC card configuration software 84, step 20. Software 84 also includes alert generation capabilities, such that when it receives a signal from the signal generator 86, it co-operates with the operating system 64 to display a dialog box to the user via the monitor 56, informing the user that a call waiting signal has been detected over the PSTN connection.

The dialog box will present the user with options, step 22, to take the new call (referred to below as “call 2”, with the original data call being “call 1”), or to reject the call. If the user chooses to reject the call, the PC card software 84 instructs the call management software 66 to maintain the data call as normal, step 24. The tone detector then continues to monitor the line for new call waiting signals step 12. A timeout way be built into the system in cases where a call waiting signal is repeated for e.g. 20 seconds, so that the further signals received from the same PSTN line and relating to the same waiting call are ignored due to the user having chosen to reject this call.

In cases where the user chooses to take the call in step 22, the user will lift the handset and choose how to take the call in the normal fashion. This generally involves a series of keypresses which generate DTMF tones to the PSTN exchange instructing it to maintain one or both calls. For example, pressing the “recall” button on the handset followed by digit 1 may terminate call 1 and switch to call 2, whereas pressing “recall” followed by digit 2 may toggle between the calls, i.e. place the active call (in this case call 1) on hold and switch to the held call (in this case call 2).

The tone detector monitors the line for these DTMW signals, step 26 and if it detects a signal to disconnect call 1, step 28, generates an appropriate signal to the PC card software, which in turn informs the call management software to disconnect the data call. When the data call ends, step 14, the tone detector is turned off, step 16.

If the tone detector detects DTMF signals instructing the exchange to toggle between calls, step 30, a different signal is generated to the PC card software 84 and thee RC card software informs the call management software that the data call is now on hold. The call management software maintains the data call in an inactive state, step 32, and awaits further instructions to reactivate or to terminate the call.

The tone detector 84 continues to monitor for new DIM signals and may detect either a toggle signal, step 34 or a signal to disconnect call 2 and return to call 1, step 38.

In the case of a new toggle signal, step 84, a signal generated by the generator 86 causes the PC card software to instruct the call management software to reactivate the data call. The process reverts to step 26.

If a DTMF signal is detected instructing the exchange to disconnect call 2, step 38, the data call is similarly reactivated and the process reverts to step 12.

By means of the invention, the user can use a single line to make e.g. Internet calls while maintaining the capability of detecting the call waiting signals normally heard during voice calls.

The invention is not limited to the embodiments described herein which may be varied or modified without departing from the scope of the invention.

I claim:

1. A call waiting indicator comprising:
a) a tone detector associated with a computer having a telephony connection, said tone detector comprising an input for receiving a signal from the telephony connection and a discriminator for identifying a signal indicative of a waiting call; and
b) a signal generator connected to the tone detector and configured to generate a signal to software resident on the computer upon detection of a call waiting signal, whereby said software can alert a user of the compute via an output device of the computer that a call waiting signal has been detected.

2. A call waiting indicator according to clam 1, wherein said discriminator comprises an audio signal sampler for sampling said input signal, a sample store for storing a sample call waiting signal, and a matching unit for determining whether a match exists between a sample of the input signal and a stored sample.

3. A call waiting indicator according to claim 1, further comprising a configuration limit for selecting one or more sample signals from a plurality of available signals and for storing said selected signal(s) in said sample store.

4. A call waiting indicator according to claim 1, wherein said alert generator communicates with the operating system of the computer and comprises a command generator for generating a command to the operating system causing the operating system to generate said alert.

5. A computer system comprising:
a) a port for a telephony connection;
b) a processor;
c) a telecommunications manager for managing the transfer of data between the processor and the port;
d) a user interface connected to the processor comprising at least an output device capable of issuing an alert to a user,
e) a tone detector connected to the port, said tone detector comprising an input for receiving a signal from the telephony connection and a discriminator for identifying a signal indicative of a waiting call; and
f) a signal generator connected to the tone-detector and configured to generate a signal when a call waiting signal has been detected, whereby a user of the computer can be alerted to the waiting call.

6. A computer system according to claim 5, wherein said signal generator communicates with alert generation software resident on the computer, said software comprising instructions effective to recognise a signal from the signal generator and to generate an alert to a user of the computer via said interface.

7. A computer system according to claim 5, wherein said alert includes an option for the user to terminate an existing data session under the control of the telecommunications manager, and said interface further includes an input device for enabling the user to select said option.

8. A computer system according to claim 5, further comprising a call control signal generator for outputting a call control signal to said connection to control the remote handling of said waiting call and/or said data session.

9. A computer system according to claim 5, wherein said output device comprises a loudspeaker and said alert includes an audio alert.

10. A computer system according to claim 5, wherein said output device is a display unit and said alert is a visible alert displayed on said display unit.

11. A computer system according to claim 5, wherein said telecommunications manager controls a modem connected to the port and wherein said input to said tone detector is taken the input or output of said modem.

12. A computer system according to claim 5, wherein said tone detector and said signal generator are embodied on a PC card mounted on the computer.

13. A computer program comprising instructions which when executed on a computer are effective to cause the computer to:
a) monitor a telephony input signal to the computer during a data transfer between the computer and a telephony connection;
b) detect a signal indicative of a waiting call available from said telephony connection; and
c) upon detection of a signal indicative of a waiting call, generate a signal to the computer whereby an alert can be provided to a user of tie computer via an output device of the computer.

14. A computer program according to claim 13, wherein said alert includes a user-selectable option to terminate said data transfer.

15. A computer program according to claim 13, wherein said alert includes a user-selectable option to place said data transfer on hold.

16. A computer program according to claim 13, when embodied in the firmware of a PC card.

17. A computer program comprising instructions which when executed on a computer are effective to cause the computer to;
a) monitor a PC card input signal to the computer for a signal indicative of a waiting call detected by the PC card; and
b) upon detection of a signal indicative of a waiting call, generate an alert to a user of the computer via an output device of the computer.

18. A computer program according to claim 17, further comprising instructions effective to cause a computer to present a user with a tool for selecting one or more signals indicative of a waiting call from a plurality of candidate signals accessible from the computer.

19. A computer program according to claim 17, further comprising instructions effective to program a PC card with an identifier corresponding to an audio signal indicative of a waiting call.

20. A database comprising a plurality of signal identifiers, each signal identifier being characteristic of a call waiting signal generated by a public switched telephone network (PSTN) exchange and enabling a match to be made between said identifier and an incoming telephony signal to a computer connected to said exchange.

21. A method of alerting a user of a computer to a waiting call available from a telephony connection to which the computer is connected, said method comprising the steps of:
a) monitoring a telephony input signal to the computer during a data transfer between the computer and a telephony connection;
b) detecting a signal indicative of a waiting call available from said telephony connection; and
c) upon detection of a signal indicative of a waiting call, generating an alert to a user via an output device of the computer.

22. A method according to claim 21, further comprising the step of providing a user of the computer with an option to terminate or place on hold said existing data session.

23. A telecommunications system comprising a connection to a telephony network, a computer system connected to said connection and a telephony terminal connected to said connection, wherein the computer system comprises:
a) a port for said telephony connection;
b) a processor;
c) a telecommunications manager for managing the transfer of data between the processor and the port;
d) a user interface connected to the processor comprising at least an output device capable of issuing an alert to a user;
e) a tone detector connected to the port, said tone detector comprising an input for receiving a signal from the telephony connection and a discriminator for identifying a signal indicative of a waiting call; and
f) an alert generator connected to the tone detector and configured to alert a user of the computer via said interface that a call waiting signal has been detected;
whereby upon said alert being generated, the waiting call can be taken at said telephony terminal.

24. A telecommunications network comprising a plurality of interconnected exchanges, at least one of said exchanges including a call waiting signal generator for generating a call waiting signal when a call is placed to an endpoint at which an existing call is in progress, and an endpoint connected to said one of said exchanges, said endpoint comprising a computer system connected to said exchange and a telephony terminal connected to said exchange, wherein the computer system comprises:
a) a port for connection to the exchange;
b) a processor;
c) a telecommunications manager for managing the transfer of data between the processor and the port;
d) a user interface connected to the processor comprising at least an output device capable of issuing an alert to a user;
e) a tone detector connected to the port, said tone detector comprising an input for receiving a signal from the telephony connection and a discriminator for identifying a signal indicative of a waiting call; and
f) an alert generator connected to the tone detector and configured to alert a user of the computer via said interface that a call waiting signal has been detected;
whereby upon said alert being generated, the waiting call can be taken at said telephony terminal.

25. A telecommunications network according to claim 26, wherein said computer further comprises a call control signal generator for outputting a call control signal to said exchange, and wherein said exchange further includes a call manager responsive to said call control signal to control the handling of said waiting call and/or said data session.
